(19) United States
(12) Patent Application Publication
(10) Pub. No.: US 2016/0034378 A1
(43) Pub. Date: Feb. 4, 2016

(54) METHOD AND SYSTEM FOR TESTING PAGE LINK ADDRESSES

(71) Applicant: Alibaba Group Holding Limited, George Town (KY)

(72) Inventor: Peng Li, Hangzhou (CN)

(21) Appl. No.: 14/812,276

(22) Filed: Jul. 29, 2015

(30) Foreign Application Priority Data
Jul. 31, 2014 (CN) 201410373731.0

(51) Int. Cl. G06F 11/36; G06F 17/30

(52) U.S. Cl. CPC G06F 11/3612; G06F 17/30887

(57) ABSTRACT

Testing page link addresses is disclosed including searching in a page to locate a link having an empty link address based on empty link attribute features, performing simulated triggering on the located link having the empty link address, determining whether the empty link address within the located link opens a new page upon the simulated triggering to obtain a determination result, and determining whether the located link having the empty link address was erroneously set as an empty link based on the determination result.

### CROSS REFERENCE TO OTHER APPLICATIONS

This application claims priority to People's Republic of China Patent Application No. 201410373731.0 entitled A METHOD, A CLIENT, AND A DEVICE FOR TESTING PAGE LINK ADDRESSES, filed Jul. 31, 2014 which is incorporated herein by reference for all purposes.

### FIELD OF THE INVENTION

The present application relates to a method and a system for testing page link addresses.

### BACKGROUND OF THE INVENTION

As Internet technology develops, more users need to acquire information through the Internet. One common approach involves users using browsers to open pages to acquire information. In a page opened by a user, a user can also click on a link in the opened page to open another page.

Typically, triggering effects of content and links displayed in the page are developed and designed in advance. Typically, the page development process includes a programmer developing a design and laying out a page. Then, a page filler performs the corresponding content filling. Following testing, the page is put online for users to browse. In the page development process, the programmer typically will set link addresses requiring transfer in the page as empty links. For example, the link addresses are set to “#” in HyperText Markup Language (HTML). The default behavior of these empty links is typically to open a page having a Uniform Resource Locator (URL) address being the same as the current page URL less the hash value portion. When the page filler fills the page, the programmer will substitute the true target addresses for the empty link addresses. As pages increase in complexity, the page filler often will omit modifying the empty link addresses described above. As a result, when users click on the link, the users are unable to open the target page. Instead, the users open a page having a URL that is the same as the current page URL less the hash value portion. The users not only fail to access the designated page to be transferred, but also have an unsatisfactory experience. The link addresses for the links in some pages are empty links intentionally set by programmers to achieve specific purposes. For example, by clicking on an empty link, the empty link returns to the top of the page, or a user's empty link click is captured by a script for corresponding processing. Empty links of this type typically will not open a page having a URL being the same as the current page URL less the hash value portion.

Conventionally, a manual approach is typically used to locate and analyze empty links in a page to determine whether the empty links were intentionally set as empty links by a programmer or were erroneously set as empty links because of a filling omission or other reason. When the manual approach is performed to eliminate erroneous empty links, a tester is to locate each empty link and analyze relevant attribute features of the links and scripts associated with the links. In the case of an empty link including a complex script, ample experience and solid skills are typically required to determine whether the empty link was erroneously set as an empty link. Some empty links that were set by programmers that use scripts to capture empty link click events and block page transfers do not have obvious attribute features. It is very difficult for a tester to know whether the empty link is intentionally empty and to know which scripts can capture the click events for these empty links and the processing logic for these scripts. As a result, the tester is often unable to determine whether such empty links were erroneously set as empty links. Therefore, when the manual approach is employed to troubleshoot erroneously set empty links, the troubleshooter typically needs to spend large amounts of time and energy to analyze the empty link. Moreover, situations may also often occur where it is very difficult to determine whether the empty link was incorrectly set as an empty link. As a consequence, the tester is much less efficient when troubleshooting the page's empty links.

### BRIEF DESCRIPTION OF THE DRAWINGS

Various embodiments of the invention are disclosed in the following detailed description and the accompanying drawings.

FIG. 1A is a flowchart of an embodiment of a process for testing page link addresses.

FIG. 1B is a flowchart of an embodiment of a process for checking a page.

FIG. 1C is a flowchart of another embodiment of a process for checking a page.

FIG. 1D is a flowchart of an embodiment of a process for subjecting a located link having an empty page link address to simulated triggering.

FIG. 2 is a flowchart of an embodiment of a process for determining whether an empty link within a link opens a new page.

FIG. 3 is a flowchart of another embodiment of a process for testing page link addresses.

FIG. 4 is a modular structural diagram of an embodiment of a client device for testing page link addresses.

FIG. 5 is a modular structural diagram of an embodiment of a simulated triggering module.

FIG. 6 is a modular structural diagram of an embodiment of a new page determining module.

FIG. 7 is a modular structural diagram of another embodiment of a new page determining module.

FIG. 8 is a modular structural diagram of another embodiment of a client device for testing page link addresses.

FIG. 9 is a modular structural diagram of an embodiment of an auxiliary page determining module.

FIG. 10A is a modular structural diagram of another embodiment of an auxiliary page determining module.

FIG. 10B is a modular structural diagram of an embodiment of a device for testing page link addresses.

FIG. 11 is a diagram of an embodiment of a system for testing page link addresses.

FIG. 12 is a functional diagram illustrating an embodiment of a programmed computer system for testing page link addresses.

### DETAILED DESCRIPTION

Embodiments of the application can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Typically, pages browsed by users correspond to text files. Markers can be added to text files to mark elements (which can include text, images, or video) in a page. For example, the markers indicate text font sizes and layouts, image sources, and display positions. A browser can read information in the page file in order. Then, the browser can interpret and display the page's marked content based on the markers. The markers can be descriptive language that marks up each element and page structure. Hyper Text Markup Language (HTML) is a common markup language typically used. HTML is a markup language which was designed for page creation and other information that can be seen in a browser. HTML can be used to format information in the page to be displayed. Typically, all the elements in the page and page structure are defined by HTML. In addition, more complex functions can be designed by integrating other design and development languages, such as JavaScript, Active Server Pages (ASP), and other script languages.

A page typically can also include links that direct a user to other associated pages or nodes. A link can include a Uniform Resource Locator (URL) specific link target address. The user can trigger or activate the URL by clicking on the URL, which causes the browser to send an HTTP GET or POST request to the server corresponding to the URL and thus be transferred to a new page indicated by the URL. The new page can be designed in advance based on the markers. In the event that a designer-programmer develops a design for a page, typically the link addresses that require transfer are first set as empty links in the page, and a page filler fills in the appropriate link addresses based on pages that require transfer. In HTML, elements can be defined and described with HTML tags. HTML tags are basic units in HTML and can include markers for identifying HTML's different definitions and descriptions of the elements. Links in HTML typically can be defined and described based on paired <a> and </a> tags. The paired <a> and </a> tags are to be uniformly indicated here as “a” tags. A basic format of the “a” tags can be: <a href=“url”>link text</a>. In some embodiments, href is used to describe attributes of the “a” tag. The href is used to express a designated link address for page transfer after the link is triggered. For example: <a href=“http://www.taobao.com”> is a link to “Taobao”</a>. In HTML, empty links can be expressed as: “#.” Links including empty links can be expressed as: <a href=“#”>link text</a>. The default behavior performed by the client application in response to the empty link being selected can be to open a page which is the same as the original page less the URL hash value portion.

The empty link in the page can be an empty link that was intentionally set by a programmer-designer to capture user clicks and trigger corresponding processing actions. The empty link can also be an empty link that was erroneously set because of a page filler's omission. A process and system for testing page links are provided. By analyzing data generated as a result of triggering links that include empty links in a page, the process and system determine whether the empty links in the page were erroneously set as empty links or intentionally set to capture user actions.

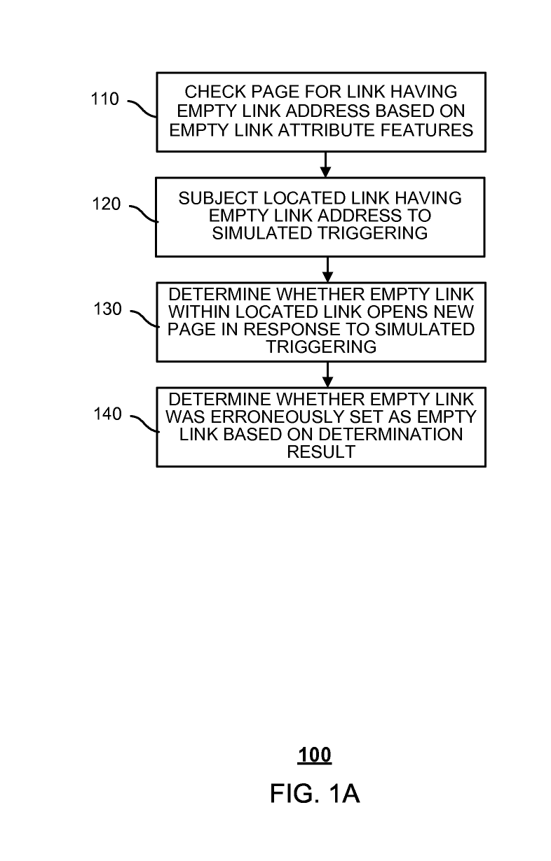

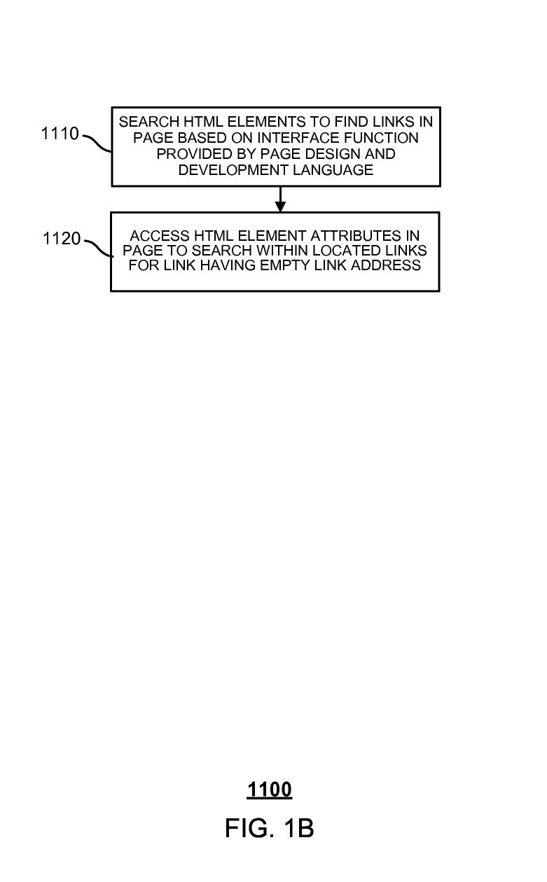

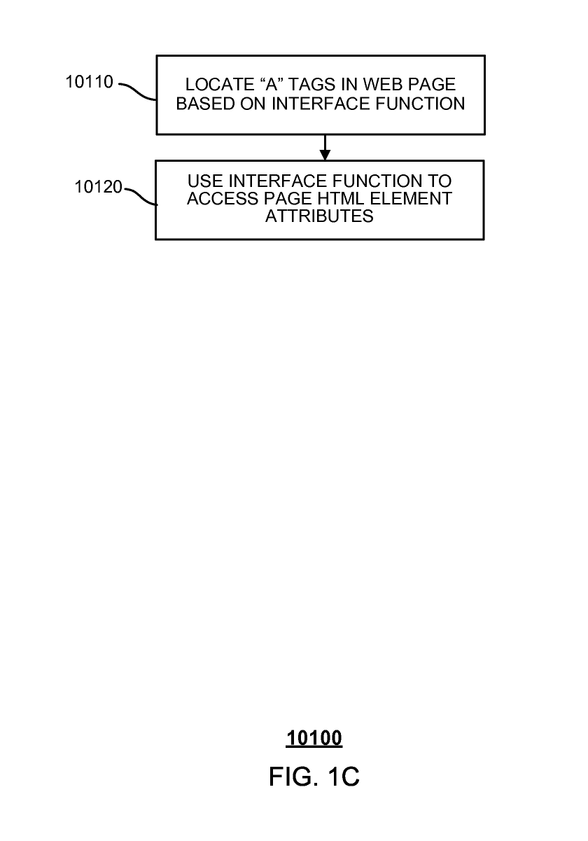

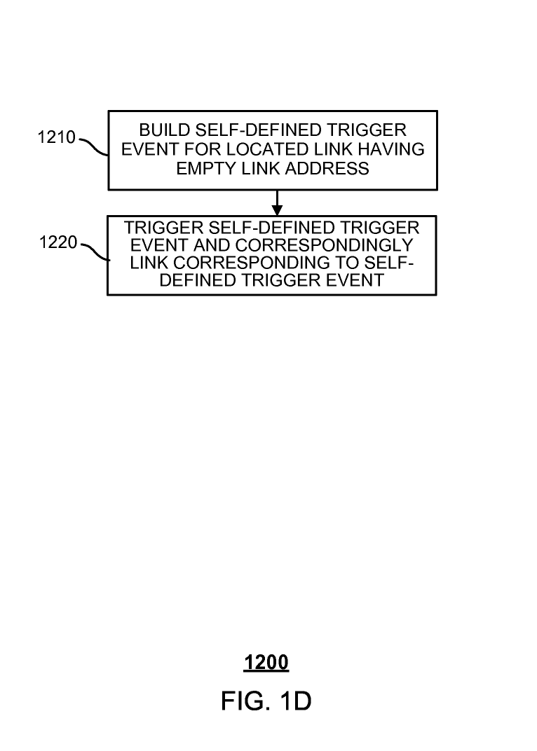

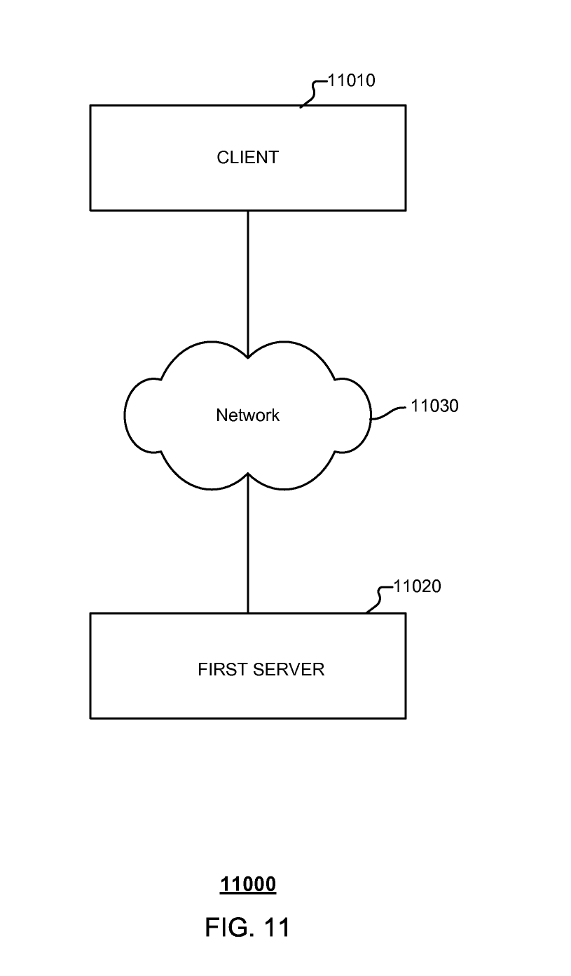

FIG. 1A is a flowchart of an embodiment of a process for testing page link addresses. In some embodiments, the process 100 is implemented by a client application (e.g., a browser application or the like) executing on a client device 11010 of FIG. 11 and comprises:

In 110, the client application executing on the client device checks a page for a link having an empty link address based on empty link attribute features.

The empty link typically includes a page link transfer target URL that is empty. Empty links in the page typically have certain attribute features that differentiate the empty links from other links. Various page design and development languages can correspond to various empty link attribute features. For example, as stated above, in the event HTML is used to design and develop a page, the links in the page typically use “a” tags to implement definitions and descriptions. An empty link in the “a” tag attribute feature can include an “a” tag with an href attribute, and a value of the href attribute can be “#” (e.g., <a href=“#”>link text</a>). Therefore, the client can use a searching function provided by a design and development language or a custom searching function to search the page for links having empty link addresses. In some embodiments, the design and development languages include page programming language HTML and a script language such as ASP, PHP or JavaScript and other page design and development languages that implement the functions to be performed by the client application.

FIG. 1B is a flowchart of an embodiment of a process for checking a page. In some embodiments, the process 1100 is an implementation of operation 110 and comprises:

In 1110, the client searches HTML elements to find links in the page based on an application programming interface (API) function provided by a page design and development language.

In 1120, the client accesses HTML element attributes in the page to search within the located links for a link having an empty link address based on an API function provided by the page design and development language.

In practice, different page design and development languages can have different ways to search for elements and/or have different parameters when accessing the elements. When link addresses in the page are searched to determine whether the link addresses are empty links, a combination of at least one function from at least one page design and development language can be used, or nesting can be performed to search the page for the links having an empty link address.

In some embodiments, the script language JavaScript can be used for searching link addresses in the page to find a link having an empty link address.

FIG. 1C is a flowchart of another embodiment of a process for checking a page. In some embodiments, the process 10100 is another implementation of operation 110 and comprises:

In 10110, the client locates “a” tags in the web page using an API function. For example, the client uses getElementsByTagName( ), provided by the script language JavaScript to search for HTML elements in a page.

In the HTML language, typically, an “a” tag (also referred to as an anchor) can be used to indicate a complete link in a page. The client can locate “a” tags in the web page based on an API function, getElementsByTagName( ), provided by the script language JavaScript, to search HTML elements in a web page.

In 10120, after the client locates the “a” tags, the client can use the API function, getAttribute function ( ), provided by the script language JavaScript to access the page HTML element attributes to locate, among the located “a” tags, “a” tags that have an href attribute value of “#.” In some embodiments, a space exists on both sides of the “#.”

In the HTML language, the “a” tag can include multiple attribute fields for describing the “a” tag. For example, a transfer target link address when the “a” tag is triggered is set and represented in the href attribute of the “a” tag. An empty link can be represented in HTML by the “#” symbol. Therefore, “a” tags located in a page by the client which have an href attribute value of “#” are the links in the page having empty link addresses. For uniformity, links having link addresses corresponding to “#” are called empty links. The links having empty link addresses can include the empty links and the links with other attribute fields in the links. Using <a href=“#”>link text</a> as an example, “#” corresponds to an empty link, and “href” corresponds to an attribute field. Typically, the client can define link names for the located links having empty link addresses. For example, a link name is defined for a first located link (<a href=“#”>link text</a>) having an empty link address: EmptyLink001.

In different page design and development language environments, the empty links can correspond to different attribute features. The client can search the page for links having empty link addresses based on empty link attribute features.

Referring back to FIG. 1A, in 120, the client performs simulated triggering on the located link having the empty link address.

After the client searches the page for a link having an empty link address, the client can subject the link having the empty page link address to simulated triggering. The simulated triggering can include a preset action event trigger. The client can simulate a manually executed preset action such as a mouse click, a mouse slide-over, or a mouse hover by invoking an event triggering function of a page design and development language (e.g., a mouse click function, a mouse slide-over function, a mouse hover function, etc.).

FIG. 1D is a flowchart of an embodiment of a process for subjecting a located link having an empty page link address to simulated triggering. In some embodiments, the process 1200 is an implementation of operation 120 and comprises:

In 1210, the client (e.g., the browser application) builds a custom trigger event for a located link having an empty link address.

The client can build a custom trigger event for the located link having an empty link address to trigger the link. The custom trigger event typically can include simulating operating actions performed by a user while browsing a page, e.g., a mouse clicking the link or a mouse sliding to the link. The client can build the custom trigger event based on a page design and development language. For example, the client can use the createEvent ( ) function and the initEvent ( ) function provided by the script language JavaScript to create and declare the custom trigger event. The custom trigger events can include “click” events or “touch” events. For example, using the JavaScript code below, a custom trigger event “event001” can be built for mouse clicking:

var event001=document.createEvent(“MouseEvents”);

event001.initEvent(“click”);

The above building of the custom trigger event, event001, can be expressed as a trigger event when clicked by a mouse. The code can be read from a source such as a file stored locally or remotely on a network, using a client application such as the browser or the like.

In 1220, the client triggers the custom trigger event, and correspondingly the link corresponding to the custom trigger event.

The client can trigger (invoke) the custom trigger event built for the link having the empty link address by invoking an API function. When the custom trigger event is triggered, the link corresponding to the custom event can be regarded as having been triggered. For example, the dispatchEvent ( ) function provided by the script language JavaScript can be used to trigger the custom trigger event. For example, the client, after locating the link having the empty link address, can define a link name for the link having the empty link address as an object EmptyLink001. At this point, the client can trigger the custom trigger event, event001, using the EmptyLink001.dispatchEvent (event001) function and thus trigger the link EmptyLink001 and complete the mouse-click simulated triggering by the client of the located link having the empty link address.

The present embodiment makes use of the common script language JavaScript, which is one of the page design and development languages. Because of interface restrictions provided by JavaScript, one custom trigger event can only be triggered once. When testing a next empty link, rebuilding the custom trigger event is to be performed (e.g., the code comprising the custom trigger event is reloaded and/or reexecuted). Therefore, setting different custom trigger events for different located links having empty link addresses is possible. Of course, when the client subjects located links having empty link addresses to simulated triggering, the following situation can occur: predefining a custom trigger event when another page design and development language is used and then uniformly invoking, by the client, the same predefined custom trigger event for the located links.

In 130, the client determines whether the empty link within the located link opens a new page in response to the simulated triggering.

In some embodiments, the link default action for a link (empty link) having a page link address that is “#” includes opening a new page. The link default action is an action that is performed by the browser application when the link is selected. The new page can be a page that is the same as the original page except the URL hash value portion is omitted. In other words, the two pages can have the same content, including the same built-in JavaScript programs, links, formatting, etc. In a first situation, the page having the page link address corresponding to “#” can include script language intentionally set by a page programmer-designer. Thus, when the link having the page link address of “#” is selected, the default link action is not performed. Instead, the script language, i.e., JavaScript, acquires the user action through the user link triggering and performs appropriate processing based on the user action. In a second situation, the link does not execute the link default action when the page link address is “#.” The script language or a link attribute included in the link having a page link address that is “#” can be set to open a new page when the link is triggered. In this situation, the new page that is opened is different from the original page. In other words, in the second situation, although the link having a page link address that is “#” opens a new page through simulated triggering, this new page can be opened by script language set in the link or by another link attribute and is not opened by the “#” link (empty link) included in the link. Therefore, an empty link set in the above first or second situation can be regarded as an empty link that was not erroneously set.

To determine whether the empty link within the link opens a new page when subjected to simulated triggering, after the client subjects the link including an empty link to simulated triggering, the client can determine whether the URL of the new page can be acquired.

If the client does not open a new page through the simulated triggering and thus fails to acquire the URL of a new page, this failure could indicate that the empty link within the link is not an empty link that was erroneously set but intentionally programmed. When the empty link within the link fails to open a new page upon being subjected to simulated triggering, the client performs processing based on preset processing operations. For example, the client determines whether the next link address in the page is an empty link by checking for the empty link symbol (e.g., “#”). The acquiring of the URL can include acquiring URLs as the page's URL based on the return value of the API function that performs the simulated triggering. Typically, if the client does not open a new page, or if the function for acquiring the URLs fails to acquire a valid URL for a new page because of a script language setting, a return value of the function for acquiring URLs will display an illegal URL, e.g., “undefined” or “null.”

If the client can open a new page as a result of the default action, the client can perform processing as follows:

First, the client acquires the URL of the new page.

The client can acquire a valid URL to open a new page with the URL acquired parameters after the triggering of the page design and development language link. For example, the parameters refers to the URL information of the triggered page.

Second, the client compares the acquired new page URL with the acquired original page URL to determine whether the new page URL and the acquired original page URL are the same and determine whether the empty link within the link opens a new page based on the comparison result.

The client can acquire an original page URL of the page to be tested. Please note that the client can, at any stage prior to the comparing of the new page URL with the original page URL, acquire the original page URL. For example, the client can, before executing the link which was located in the acquisition operation having an empty link address, acquire the URL of the original page. No time restrictions are imposed as to when the original page URL is acquired before the client conducts the comparison.

The client can compare the acquired new page URL with the original page URL to determine whether the acquired new page URL and the original page URL are the same. The acquired new page URL or the original page URL can be in a character string format. Therefore, the client, based on the comparing of the character strings of the new page URL and the original page URL to determine whether they are the same, can compare the new page URL and the original page URL to determine whether the new page URL and the original page URL are the same. In the event that the comparison result indicates that the acquired new page URL and the original page URL are the same, that could mean that the newly opened page is the same page as the original page because the newly opened page is opened by triggering the empty link address within the link. The client can determine that the empty link address within the link opens a new page. In the event that the comparison result indicates that the newly opened page is not the same as the original page, the comparison result also indicates that the empty link address within the link does not open a new page.

In another situation, the URL can include a “#” locator. A hash value follows the “#” and can be used to designate a location within the page. For example, http://www.example.com/index.html#print could indicate that, after the browser fetches this URL, the browser will automatically scroll the mark corresponding to “print” to the visible area. When the client acquires a new page URL and at least one item in the acquired original page URL includes a hash value, the client compares the acquired new page URL with the acquired original page URL to determine whether the acquired new page URL and the acquired original page URL are the same. The above comparison operation can include: eliminating the hash value from the acquired new page URL (e.g., removing the hash value from the URL string) and eliminating the hash value from the acquired original page URL, and comparing the resulting new page URL after eliminating the hash value with the resulting original page URL to determine whether the URLs are the same.

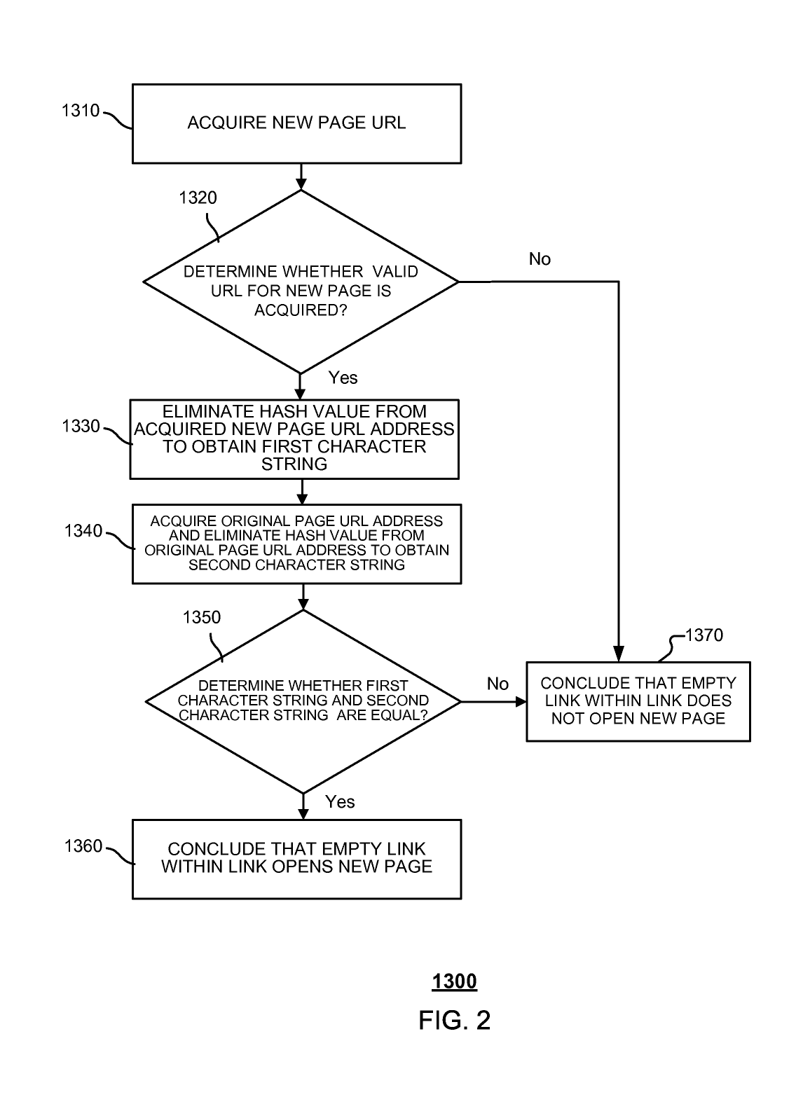

FIG. 2 is a flowchart of an embodiment of a process for determining whether an empty link within a link opens a new page. In some embodiments, the process 1300 is an implementation of operation 130 of FIG. 1A and comprises:

In 1310, the client acquires a new page URL.

The client can attempt to acquire a new page URL. For example, it is possible that the API function window.location.href provided by the script language JavaScript can be used to acquire the URL of the new page opened by the simulated triggering.

In 1320, the client determines whether a valid URL for the new page is acquired (e.g., whether an API function is implemented and can be invoked to obtain a valid URL for the new page). In the event that the valid URL for the new page is acquired, control is passed to operation 1330; otherwise, control is passed to operation 1370.

In 1330, the client eliminates a hash value from the acquired new page URL to obtain a first character string.

In 1340, the client acquires an original page URL and eliminates a hash value from the original page URL to obtain a second character string.

In some embodiments, the client acquires the original page URL based the interface window.opener.location.href provided by the script language JavaScript. The client eliminates a hash value from the original page URL to obtain the second character string.

In 1350, the client compares the first character string and the second character string to determine whether the first character string and the second character string are equal. In the event that the first character string and the second character string are equal, control passes to operation 1360; otherwise, control passes to operation 1370.

In 1360, in the event that the first character string and the second character string are equal, the client concludes that the empty link within the link opens a new page.

In 1370, in the event that the first character string and the second character string are not equal, the client concludes that the empty link within the link does not open a new page.

By comparing the new page URL with the original page URL to determine whether the new page URL and the original page URL are the same, whether the simulated-triggered empty link within the located link opens a new page can be determined.

Referring back to FIG. 1A, in 140, the client determines whether the empty link was erroneously set as an empty link based on the determination result.

The client can determine whether the empty link was erroneously set based on the determination result on whether the empty link address within the link opens a new page. If the empty link opens a new page, the opening of the new page could mean that the empty link is an erroneously set empty link. Correspondingly, if the empty link does not open a new page, the omission of the opening of the new page could mean that the empty link is not an erroneously set empty link.

When the client determines whether the empty link opens a new page based on the script language JavaScript, the opened new web page is used to store and execute the JavaScript programs. The JavaScript programs included within the new page can only be executed when the new page is opened. As for links having link addresses having been intentionally set as “#,” simulated clicking on this link will not open a new page that is the same as the original page except for the URL hash value. Therefore, operations 1310 through 1370 whereby JavaScript determines whether the empty link opens a new page are not to be executed. The simulated clicking is to be performed only on links having addresses being erroneously set as “#,” and the client is to perform operations 1310 to 1370 only when the simulated clicking opens a page including the above determination script language. All of the following situations can indicate that the empty links among links that were located on the original page were intentionally set as “#”: the client fails to open a new page or fails to acquire a valid URL, or the result of the comparing of the first character string and the second character string is that the first character string and the second character string are not the same. There can be other possible situations as well.

A process for testing page link addresses is provided. The process can locate a link having an empty page link address based on attribute features of empty links and can perform a simulated triggering of a custom trigger event of the link having the empty link address. In this process, the client can determine whether the empty link within the link opens a new web page based on a preset determination rule because of the simulated triggering. If the simulated triggering causes the empty link within the link to open a page that is the same as the original page with the URL hash value portion removed, then the located empty link within the page can be regarded as an erroneously set empty link. By using the process for checking page link addresses as provided, the client can automatically check empty links in a page to determine whether the empty links were erroneously set. The automated process improves the efficiency of troubleshooting compared to the manual checking and determining of the empty links, and reduces the omission rate associated with manual checks. In addition, the present application makes a determination based on the page transfer result following simulated triggering.

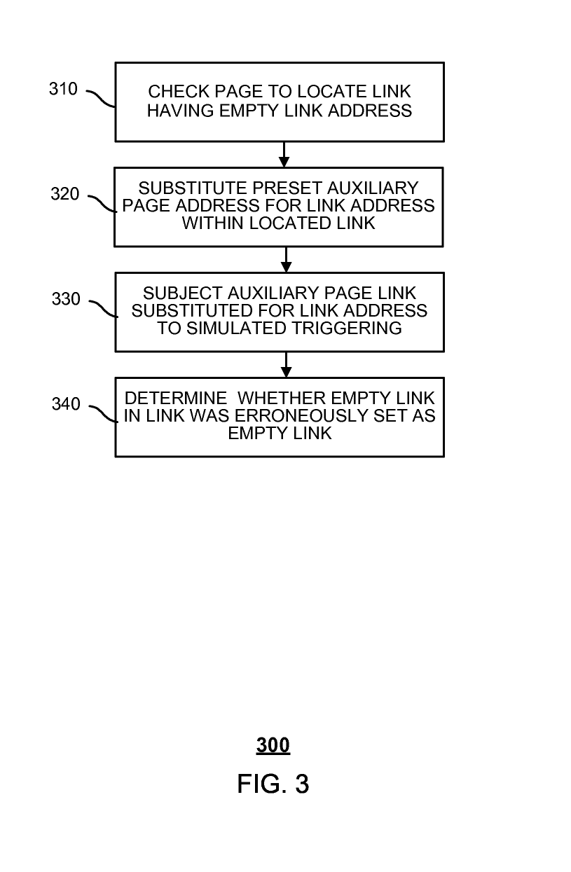

FIG. 3 is a flowchart of another embodiment of a process for testing page link addresses. In some embodiments, the process 300 is implemented by a client 11010 of FIG. 11 and comprises:

In 310, the client checks a page to locate a link having an empty link address based on empty link attribute features.

As stated above, the client can search the page for links having an empty link address based on a searching function provided by a design and development language or a custom searching function. For example, the getElementsByTagName ( ) function and the getElementsByTagName ( ) provided by the script language JavaScript can be used to search for links having an empty link address.

In 320, the client substitutes a preset auxiliary page address for a link address within the located link.

In some embodiments, the client can preset a non-empty auxiliary page URL.

Such auxiliary pages can include auxiliary pages with relevant parameters for acquiring an original page link as set by a page programmer-designer, or the auxiliary pages can be other existing, common auxiliary pages. For example, the empty link within the located link can be replaced with a preset second page such as “www.1688.com.”

In 330, the client subjects the auxiliary page link substituted for the link address to simulated triggering.

The simulated triggering process can be the same as the simulated triggering process of process 100 of FIG. 1A. In some embodiments, the client can build a custom trigger event and trigger the custom trigger event to subject the link to simulated triggering. For example, the client can build a custom trigger event for the located link having an empty link address. The client triggers the custom trigger event, and accordingly, the link corresponding to the custom trigger event is triggered.

In 340, the client determines whether the simulated triggering has opened the auxiliary page and determines whether the empty link in the link was erroneously set as an empty link based on the determination result.

In some embodiments, the process whereby the client determines whether the simulated triggering has opened the auxiliary page includes: acquiring a new page URL and comparing the new page URL with the auxiliary page URL to determine whether the new page URL and the auxiliary page URL are the same, and in the event that the comparison result is that the new page URL and the auxiliary page URL are the same, determining that the empty link within the link opens the new page. For example, one can refer to the above process whereby the client compares the new page URL with the original page URL. In one situation, if the client fails to acquire an auxiliary page valid URL through the simulated triggering, the empty link within the located link does not open a new page upon the simulated triggering. If the client can open the auxiliary page, the opening of the auxiliary page could mean that the empty link within the link was an erroneously set empty link. In another situation, if the client cannot open a new page, or if the page opened is not the auxiliary page, the situation could mean that the empty link within the link was not an erroneously set empty link.

In yet another situation, when the new page URL acquired by the client includes a hash value, the client compares the acquired new page URL with the auxiliary page URL to determine whether they are the same. The comparison described above comprises: eliminating the hash value from the acquired new page URL and from the auxiliary page URL, and comparing the resulting new page URL after elimination of the hash value with the resulting auxiliary page URL to determine whether the addresses are the same.

By using the above page testing method, the client can preset the auxiliary page that replaces the empty link within the link. A determination of whether the link opens the auxiliary page is made based on the simulated triggering of the link. This simulated triggering of the link in turn determines whether the empty link within the link was erroneously set as an empty link. By using the process 300, the appropriate information, parameter capture, or feedback script within the auxiliary page can be set. This process 300 can increase page link checking efficiency.

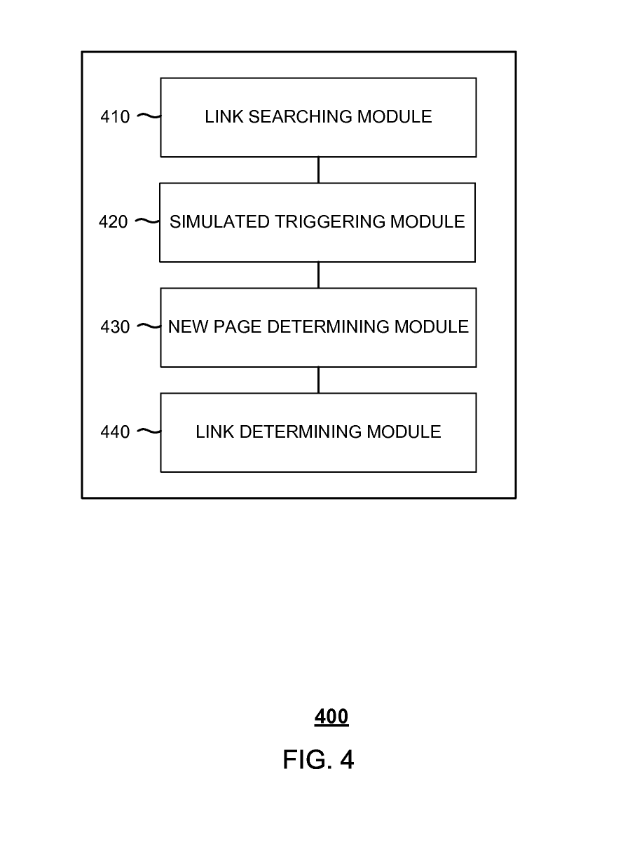

FIG. 4 is a structural diagram of an embodiment of a client device for testing page link addresses. In some embodiments, the client device 400 is configured to implement the process 100 of FIG. 1A and comprises: a link searching module 410, a simulated triggering module 420, a new page determining module 430, and a link determining module 440.

In some embodiments, the link searching module 410 is configured to check pages to locate a link having an empty link address based on empty link attribute features.

In some embodiments, when the link that is to be checked is an empty link, the attribute features include a link attribute, e.g., the “#” in HTML.

In some embodiments, the simulated triggering module 420 is configured to subject the located link having an empty link address to simulated triggering.

In some embodiments, the new page determining module 430 is configured to determine whether the empty link within the located link opens a new page upon the simulated triggering.

In some embodiments, the link determining module 440 is configured to determine whether the empty link was erroneously set as an empty link based on the determination result of the new page determining module 430.

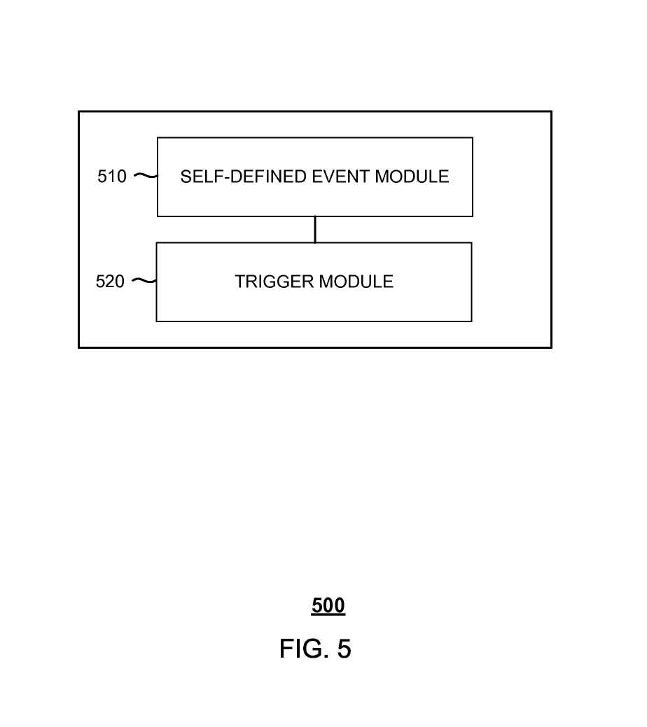

FIG. 5 is a modular structural diagram of an embodiment of a simulated triggering module. In some embodiments, the simulated triggering module 500 is an implementation of the simulated triggering module 420 of FIG. 4 and comprises: a self-defined event module 510 and a trigger module 520.

In some embodiments, the self-defined event module 510 is configured to build a custom trigger event for the located link having an empty link address.

In some embodiments, in the event that the custom trigger event that was built is triggered, correspondingly, the link corresponding to the custom trigger event is also to be triggered.

In some embodiments, the trigger module 520 is configured to trigger the custom trigger event of the self-defined event module 510.

Referring back to FIG. 4, in some embodiments, the new page determining module 430 is further configured to determine whether the simulated triggering opens a new page. In the event that, after undergoing simulated triggering by the simulated triggering module 420, the new page determining module 430 fails to acquire a new page URL, the determination result of new page determining module 430 is to be that the empty link within the link does not open a new page.

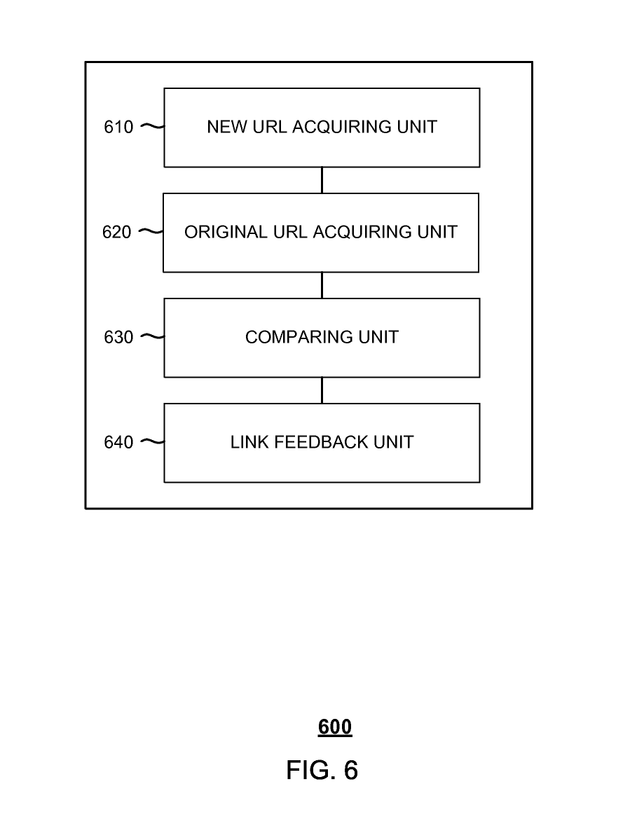

FIG. 6 is a modular structural diagram of an embodiment of a new page determining module. In some embodiments, the new page determining module 600 is an implementation of the new page determining module 430 of FIG. 4 and comprises: a new URL acquiring unit 610, an original URL acquiring unit 620, a comparing unit 630, and a link feedback unit 640.

In some embodiments, the new URL acquiring unit 610 is configured to acquire the URL of the opened new page.

In some embodiments, the original URL acquiring unit 620 is configured to acquire the URL of the original page.

In some embodiments, the comparing unit 630 is configured to compare the acquired new page URL with the acquired original page URL to determine whether the acquired new page URL and the acquired original page URL are the same.

In some embodiments, the link feedback unit 640 is configured to determine whether the empty link within the link opens a new page based on the comparison result of the comparing unit 630. The link feedback unit 640 is further configured to determine whether the empty link was erroneously set based on the comparison result of the comparing unit 630. If the empty link opens a new page, the link feedback unit 640 could conclude that the empty link is an erroneously set empty link. Correspondingly, if the empty link does not open a new page, the link feedback unit 640 could conclude that the empty link is not an erroneously set empty link. In some embodiments, the link feedback unit 640 can instruct a display to display a message informing the user that the link has been erroneously set.

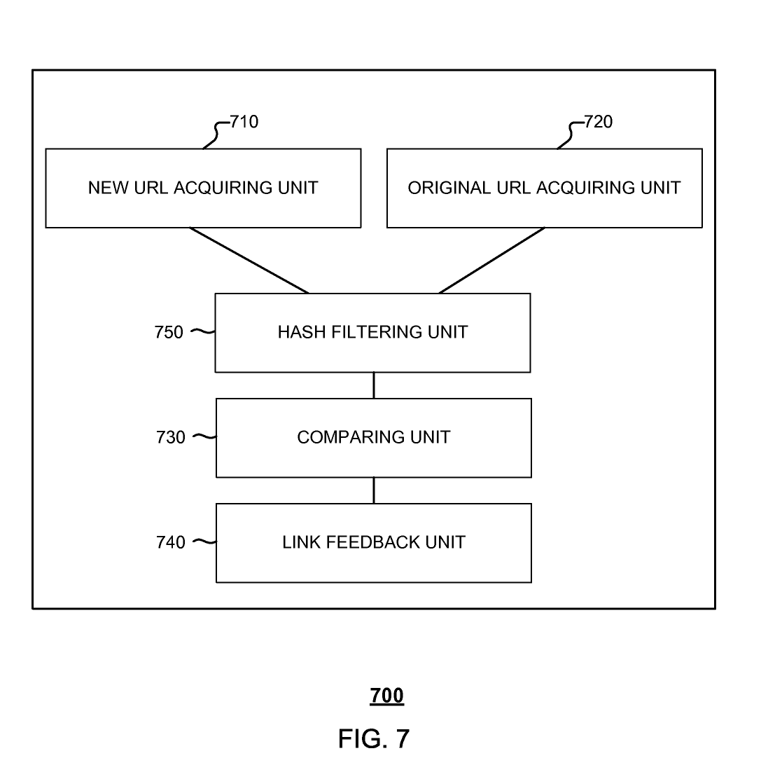

FIG. 7 is a modular structural diagram of another embodiment of a new page determining module. In some embodiments, the new page determining module 700 is an implementation of the new page determining module 430 of FIG. 4 and comprises: a new URL acquiring unit 710, an original URL acquiring unit 720, a comparing unit 730, a link feedback unit 740, and a hash filtering unit 750.

The new URL acquiring unit 710, the original URL acquiring unit 720, the comparing unit 730, and the link feedback unit 740 correspond with the new URL acquiring unit 610, the original URL acquiring unit 620, the comparing unit 630, and the link feedback unit 640 of FIG. 6, respectively.

In some embodiments, the hash filtering unit 750 is configured to eliminate the hash value from the acquired new page URL and the acquired original page URL.

In some embodiments, correspondingly, the comparing unit 730 is configured to compare the acquired new page URL and the acquired original page URL to determine whether the acquired new page URL and the acquired original page URL are the same and compare the new page URL after the elimination of the hash value with the original page URL to determine whether the new page URL and the original page URL are the same.

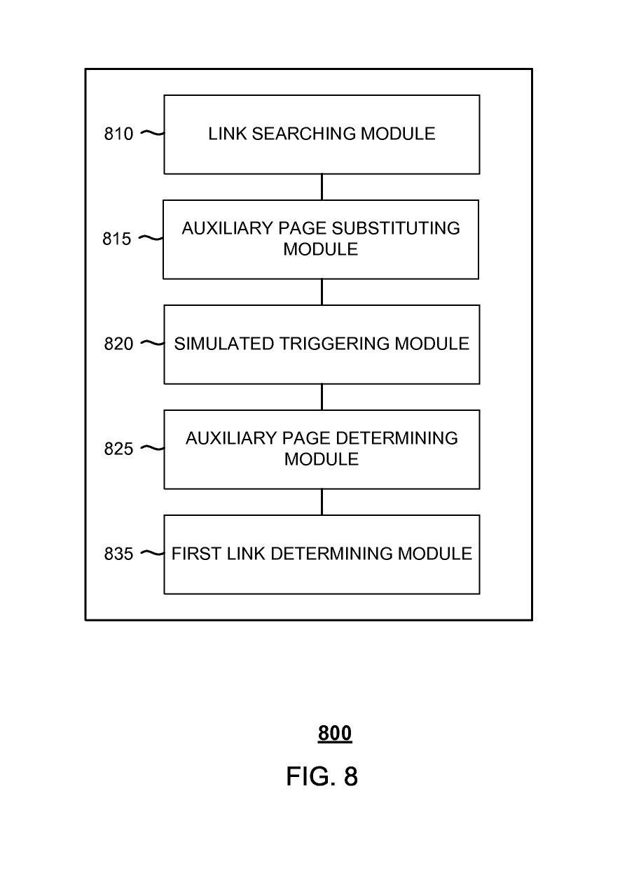

FIG. 8 is a modular structural diagram of another embodiment of a client device for testing page link addresses. In some embodiments, the client 800 is configured to implement the process 300 of FIG. 3 and comprises: a link searching module 810, an auxiliary page substituting module 815, a simulated triggering module 820, an auxiliary page determining module 825, and a first link determining module 835.

The link searching module 810 and the simulated triggering module 820 correspond to the link searching module 410 and the simulated triggering module 420 of FIG. 4, respectively.

In some embodiments, the link searching module 810 is configured to check pages for a link having an empty link address based on empty link attribute features.

In some embodiments, the auxiliary page substituting module 815 is configured to store a preset auxiliary page URL and substitute an auxiliary page address for a link address within the link located by the link searching module 810.

In some embodiments, the simulated triggering module 820 is configured to subject the auxiliary page link address substituted for the link address to simulated triggering.

In some embodiments, the auxiliary page determining module 825 is configured to determine whether the simulated triggering opens the auxiliary page.

In some embodiments, the first link determining module 835 is configured to determine whether the empty link within the link was erroneously set as an empty link based on the determination result of the auxiliary page determining module 825.

In some embodiments, the simulated triggering module 820 can be the same as the simulated triggering module 500 of FIG. 5 and can include a self-defined event module and a triggering module, which correspond with the self-defined event module 510 of FIG. 5 and the trigger module 520 of FIG. 5, respectively.

The auxiliary page determining module 825 is further configured to determine whether the simulated triggering opens the auxiliary page. If, after undergoing simulated triggering by the simulated triggering module 820, the auxiliary page determining module 825 fails to acquire an auxiliary page URL, the auxiliary page determining module 825 has a determination result that the empty link within the link does not open an auxiliary page.

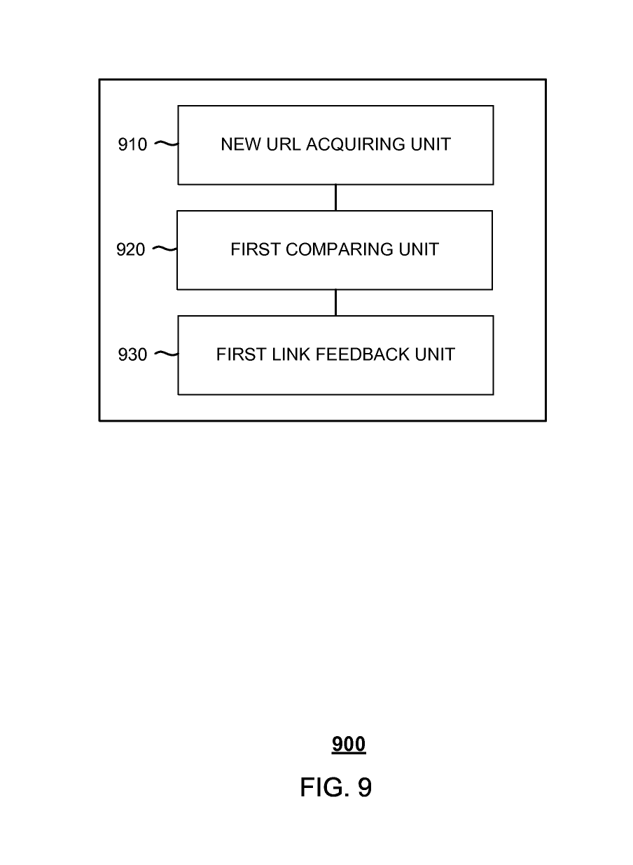

FIG. 9 is a modular structural diagram of an embodiment of an auxiliary page determining module. In some embodiments, the auxiliary page determining module 900 is an implementation of the auxiliary page determining module 825 of FIG. 8 and comprises: a new URL acquiring unit 910, a first comparing unit 920, and a first link feedback unit 930.

The new URL acquiring unit 910 corresponds to the new URL acquiring unit 610 of FIG. 6.

In some embodiments, the new URL acquiring unit 910 is configured to acquire URLs of a new page.

In some embodiments, the first comparing unit 920 is configured to compare the acquired new page URL with the auxiliary page URL stored by the auxiliary page substituting module 815 of FIG. 8 to determine whether the acquired new page URL and the auxiliary page URL are the same.

In some embodiments, the first link feedback unit 930 is configured to determine whether the empty link within the link opens the auxiliary page based on the comparison result of the first comparing unit 920.

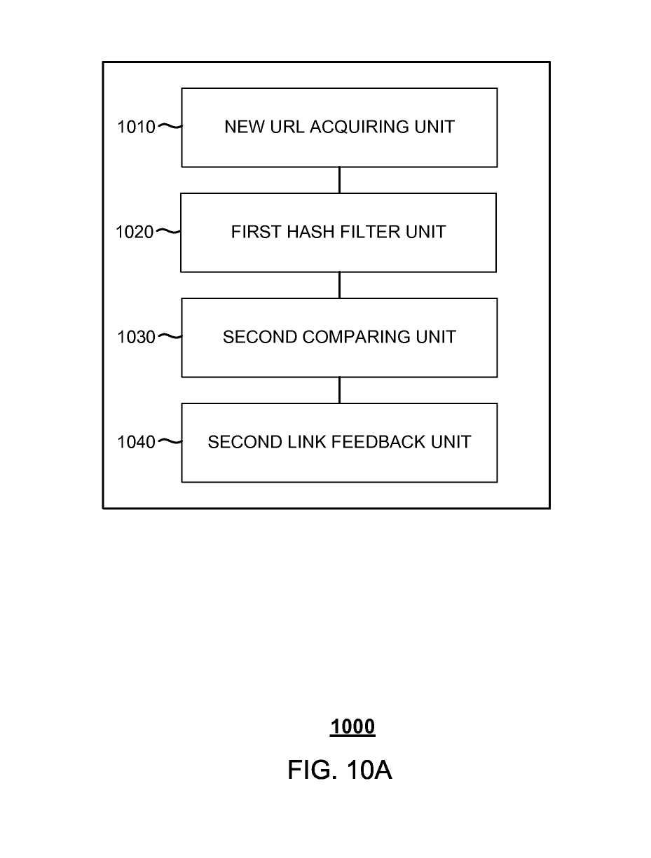

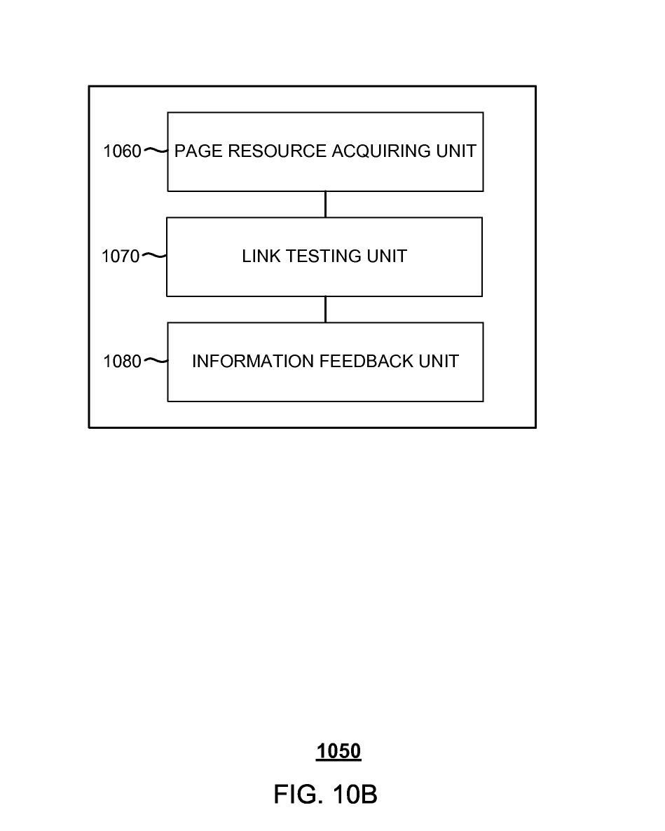

FIG. 10A is a modular structural diagram of another embodiment of an auxiliary page determining module. In some embodiments, the auxiliary page determining module 1000 is an implementation of the auxiliary page determining module 825 of FIG. 8 and comprises: a new URL acquiring unit 1010, a first hash filter unit 1020, a second comparing unit 1030, and a second link feedback unit 1040.

The new URL acquiring unit 1010, the second comparing unit 1030, and the second link feedback unit 1040 correspond to the new URL acquiring unit 910, the first comparing unit 920, and the first link feedback unit 930 of FIG. 9, respectively.

In some embodiments, the first hash filter unit 1020 is configured to eliminate the hash value from the acquired new page URL.

Correspondingly, the second comparing unit 1030 is configured to compare the acquired new page URL and the auxiliary page URL stored by the auxiliary page substituting module 815 of FIG. 8 to determine whether the acquired new page URL and the auxiliary page URL are the same, including to: compare the new page URL after the elimination of the hash value with the auxiliary page URL to determine whether the addresses are the same.

FIG. 10B is a modular structural diagram of an embodiment of a device for testing page link addresses. In some embodiments, the device 1050 comprises: a page resource acquiring unit 1060, a link testing unit 1070, and an information feedback unit 1080.

In some embodiments, the page resource acquiring unit 1060 is configured to acquire page resources for testing pages.

In some embodiments, the link testing unit 1070 is configured to determine whether empty links in the tested pages were erroneously set as empty links.

In some embodiments, the information feedback unit 1080 is configured to provide feedback of information on determinations by the link testing unit 1070 on whether empty links were erroneously set as empty links.

In some embodiments, the link testing unit 1070 includes a client for testing page link addresses. In some embodiments, the client corresponds to the client 400 of FIG. 4 or the client 800 and FIG. 8.

The testing information fed back by the information feedback unit 1080 can include information on whether the tested empty links were erroneously set and on the locations (line numbers) of the empty links.

A method, client, and device for testing page link addresses as provided can act as a substitute for manual searching for empty links in a page and can perform simulated triggering. In addition, the method, client, and device can determine whether the empty links are erroneously set as empty links by determining whether simulated triggering of the empty links opens new web pages based on a preset determination rule. By using the embodiments provided by the present application, one can check page link addresses more quickly, reduce the omission rate in empty link troubleshooting, and increase page link checking efficiency.

The modules described above can be implemented as software components executing on one or more general purpose processors, as hardware such as programmable logic devices and/or Application Specific Integrated Circuits designed to perform certain functions or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices. The functions of the modules may be merged into one another or further split into multiple sub-modules.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

FIG. 11 is a diagram of an embodiment of a system for testing page link addresses. In some embodiments, the system 11000 includes a server 11020 connected to a client 11010 via a network 11030.

The client 11010 accesses a page located on the server 11020 via a client application such as a browser or the like executing on the client, searches the page for a link having an empty link address based on empty link attribute features, subjects the located link having the empty link address to simulated triggering, determines whether the empty link address within the located link opens a new page upon the simulated triggering, and determines whether the located link having the empty link address was erroneously set as an empty link.

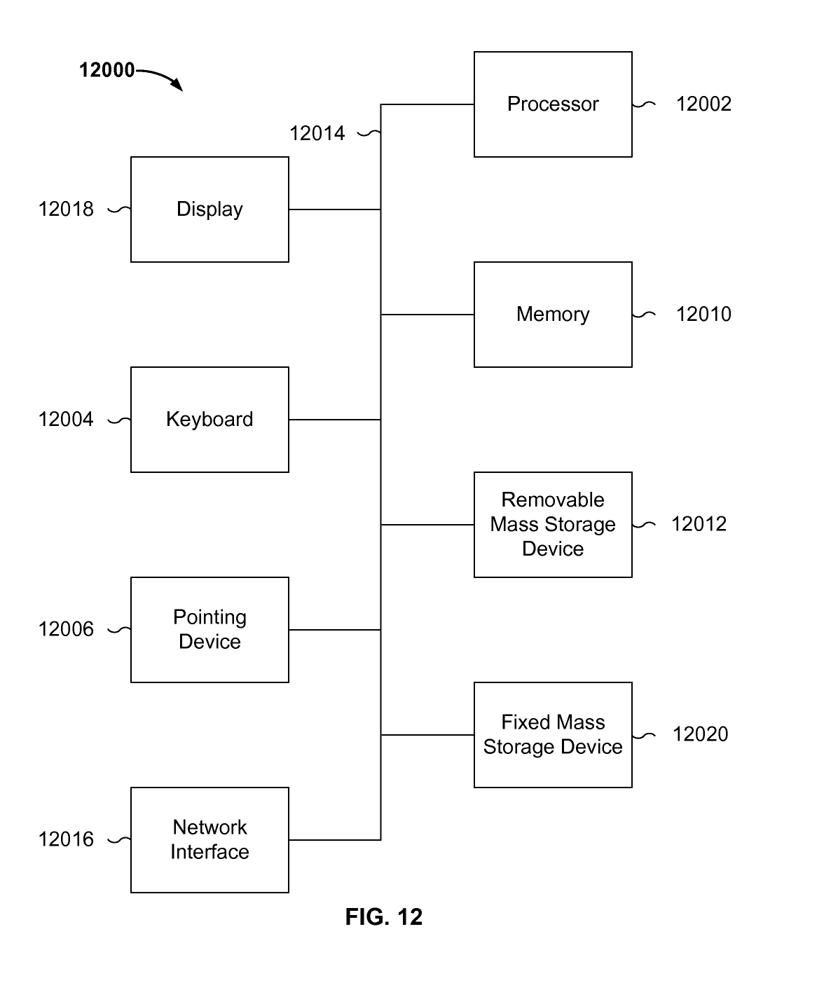

FIG. 12 is a functional diagram illustrating an embodiment of a programmed computer system for testing page link addresses. As will be apparent, other computer system architectures and configurations can be used to test page link addresses. Computer system 12000, which includes various subsystems as described below, includes at least one microprocessor subsystem (also referred to as a processor or a central processing unit (CPU)) 12002. For example, processor 12002 can be implemented by a single-chip processor or by multiple processors. In some embodiments, processor 12002 is a general purpose digital processor that controls the operation of the computer system 12000. Using instructions retrieved from memory 12010, the processor 12002 controls the reception and manipulation of input data, and the output and display of data on output devices (e.g., display 12018).

Processor 12002 is coupled bi-directionally with memory 12010, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 12002. Also as is well known in the art, primary storage typically includes basic operating instructions, program code, data, and objects used by the processor 12002 to perform its functions (e.g., programmed instructions). For example, memory 12010 can include any suitable computer-readable storage media, described below, depending on whether, for example, data access needs to be bi-directional or uni-directional. For example, processor 12002 can also directly and very rapidly retrieve and store frequently needed data in a cache memory (not shown).

A removable mass storage device 12012 provides additional data storage capacity for the computer system 12000, and is coupled either bi-directionally (read/write) or uni-directionally (read only) to processor 12002. For example, storage 12012 can also include computer-readable media such as magnetic tape, flash memory, PC-CARDS, portable mass storage devices, holographic storage devices, and other storage devices. A fixed mass storage 12020 can also, for example, provide additional data storage capacity. The most common example of mass storage 12020 is a hard disk drive. Mass storages 12012, 12020 generally store additional programming instructions, data, and the like that typically are not in active use by the processor 12002. It will be appreciated that the information retained within mass storages 12012 and 12020 can be incorporated, if needed, in standard fashion as part of memory 12010 (e.g., RAM) as virtual memory.

In addition to providing processor 12002 access to storage subsystems, bus 12014 can also be used to provide access to other subsystems and devices. As shown, these can include a display monitor 12018, a network interface 12016, a keyboard 12004, and a pointing device 12006, as well as an auxiliary input/output device interface, a sound card, speakers, and other subsystems as needed. For example, the pointing device 12006 can be a mouse, stylus, track ball, or tablet, and is useful for interacting with a graphical user interface.

The network interface 12016 allows processor 12002 to be coupled to another computer, computer network, or telecommunications network using a network connection as shown. For example, through the network interface 12016, the processor 12002 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 12002 can be used to connect the computer system 12000 to an external network and transfer data according to standard protocols. For example, various process embodiments disclosed herein can be executed on processor 12002, or can be performed across a network such as the Internet, intranet networks, or local area networks, in conjunction with a remote processor that shares a portion of the processing. Additional mass storage devices (not shown) can also be connected to processor 12002 through network interface 12016.

An auxiliary I/O device interface (not shown) can be used in conjunction with computer system 12000. The auxiliary I/O device interface can include general and customized interfaces that allow the processor 12002 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 12 is but an example of a computer system suitable for use with the various embodiments disclosed herein. Other computer systems suitable for such use can include additional or fewer subsystems. In addition, bus 12014 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
searching in a page to locate a link having an empty link address based on empty link attribute features;
performing simulated triggering on the located link having the empty link address;
determining whether the empty link address within the located link opens a new page upon the simulated triggering to obtain a determination result; and
determining whether the located link having the empty link address was erroneously set as an empty link based on the determination result.

2. The method as described in claim 1, wherein the performing of the simulated triggering on the located link having the empty link address comprises:
building a custom trigger event for the located link having the empty link address; and
triggering the custom trigger event.

3. The method as described in claim 1, wherein the determining of whether the empty link address within the located link opens a new page upon the simulated triggering comprises:
failing to acquire a new page Universal Resource Locator (URL) through the simulated triggering; or
failing to open a new page upon the simulated triggering.

4. The method as described in claim 1, wherein the determining of whether the located link having the empty link address was erroneously set as the empty link comprises:
acquiring a new page URL;
acquiring an original page URL;
comparing the acquired new page URL with the original page URL to determine whether the acquired new page URL and the original page URL are the same; and
in the event that the acquired new page URL and the original page URL are the same, determining that the empty link address within the link opens a new page.

5. The method as described in claim 4, wherein the comparing of the acquired new page URL with the original page URL to determine whether the acquired new page URL and the original page URL are the same comprises:
determining whether at least one item in the acquired original page URL comprises a hash value;
eliminating a hash value from the acquired new page URL to generate a processed new page URL and eliminating the hash value from the acquired original page URL to generate a processed original page URL; and
comparing the processed new page URL with the processed original page URL to determine whether the processed new page URL and the processed original page URL are the same.

6. A method, comprising:
searching in a page to locate a link having an empty link address based on empty link attribute features;
substituting a preset auxiliary page address for the empty link address within the located link;
performing simulated triggering on the link having the auxiliary page address substituted for the empty link address;
determining whether the simulated triggering has opened an auxiliary page to obtain a determination result; and
determining whether the empty link address in the link was erroneously set as an empty link based on the determination result.

7. The method as described in claim 6, wherein the performing of the simulated triggering on the link having the auxiliary page address substituted for the empty link address comprises:
building a custom trigger event for the located link having the empty link address; and
triggering the custom trigger event.

8. The method as described in claim 6, wherein the determining of whether the simulated triggering has opened the auxiliary page comprises:
failing to acquire an auxiliary page Universal Resource Locator (URL) through the simulated triggering; or
failing to open the auxiliary page upon the simulated triggering.

9. The method as described in claim 6, wherein the determining of whether the simulated triggering has opened the auxiliary page comprises:
acquiring a new page URL;
acquiring an auxiliary page URL;
comparing the acquired new page URL with the auxiliary page URL to determine whether the acquired new page URL and the auxiliary page URL are the same; and
in the event that the acquired new page URL and the auxiliary page URL are the same, determining that the empty link within the link opens the auxiliary page.

10. The method as described in claim 9, further comprising:
determining whether the acquired new page URL includes a hash value; and
in the event that the acquired new page URL includes the hash value:
comparing the acquired new page URL with the auxiliary page URL to determine whether the acquired new page URL and the auxiliary page URL are the same, comprising:
eliminating the hash value from the acquired new page URL to generate a processed new page URL; and
comparing the processed new page URL with the auxiliary page URL to determine whether the processed new page URL and the auxiliary page URL are the same.

11. A client device, comprising:
at least one processor configured to:
search in a page to locate a link having an empty link address based on empty link attribute features;
perform simulated triggering on the located link having the empty link address;
determine whether the empty link address within the located link opens a new page upon the simulated triggering to obtain a determination result; and
determine whether the located link having the empty link address was erroneously set as an empty link based on the determination result; and
a memory coupled to the at least one processor and configured to provide the at least one processor with instructions.

12. The client as described in claim 11, wherein the performing of the simulated triggering on the located link having the empty link address comprises to:
build a custom trigger event for the located link having the empty link address; and
trigger the custom trigger event.

13. The client as described in claim 11, wherein the determining of whether the located link having the empty link address was erroneously set as the empty link comprises to:
acquire a new page URL;
acquire an original page URL;
compare the acquired new page URL with the original page URL to determine whether the acquired new page URL and the original page URL are the same; and
in the event that the acquired new page URL and the original page URL are the same, determine that the empty link address within the link opens a new page.

14. The client as described in claim 13, wherein the comparing of the acquired new page URL with the original page URL to determine whether the acquired new page URL and the original page URL are the same comprises to:
determine whether at least one item in the acquired original page URL comprises a hash value;
eliminate a hash value from the acquired new page URL to generate a processed new page URL and eliminate the hash value from the acquired original page URL to generate a processed original page URL; and
compare the processed new page URL with the processed original page URL to determine whether the processed new page URL and the processed original page URL are the same.

15. A client, comprising:
at least one processor configured to:
search in a page to locate a link having an empty link address based on empty link attribute features;
substitute a preset auxiliary page address for the empty link address within the located link;
perform simulated triggering on the link having the auxiliary page address substituted for the empty link address;
determine whether the simulated triggering has opened an auxiliary page to obtain a determination result; and
determine whether the empty link address in the link was erroneously set as an empty link based on the determination result; and
a memory coupled to the at least one processor and configured to provide the at least one processor with instructions.

16. The client as described in claim 15, wherein the performing of the simulated triggering on the link having the auxiliary page address substituted for the empty link address comprises to:
determine whether the simulated triggering opens the auxiliary page.

17. The client as described in claim 15, wherein the determining of whether the simulated triggering has opened the auxiliary page comprises to:
acquire a new page Universal Resource Locator (URL);
acquire an auxiliary page URL;
compare the acquired new page URL with the auxiliary page URL to determine whether the acquired new page URL and the auxiliary page URL are the same; and
in the event that the acquired new page URL and the auxiliary page URL are the same, determine that the empty link within the link opens the auxiliary page.

18. The client as described in claim 17, wherein the at least one processor is further configured to:
determine whether the acquired new page URL includes a hash value; and
in the event that the acquired new page URL includes the hash value:
compare the acquired new page URL with the auxiliary page URL to determine whether the acquired new page URL and the auxiliary page URL are the same, comprising to:
eliminate the hash value from the acquired new page URL to generate a processed new page URL; and
compare the processed new page URL with the auxiliary page URL to determine whether the processed new page URL and the auxiliary page URL are the same.

19. A device, comprising:
at least one processor configured to:
acquire page resources for testing pages;
search in a page to locate a link having an empty link address based on empty link attribute features;
perform simulated triggering on the located link having the empty link address;
determine whether the empty link address within the located link opens a new page upon the simulated triggering to obtain a first determination result;
determine whether empty links in the tested pages were erroneously set as empty links based on the first determination result to obtain a second determination result; and
provide feedback of information on the second determination result; and
a memory coupled to the at least one processor and configured to provide the at least one processor with instructions.

20. A computer program product being embodied in a tangible non-transitory computer readable storage medium and comprising computer instructions for:
searching in a page to locate a link having an empty link address based on empty link attribute features;
performing simulated triggering on the located link having the empty link address;
determining whether the empty link address within the located link opens a new page upon the simulated triggering to obtain a determination result; and
determining whether the located link having the empty link address was erroneously set as an empty link based on the determination result.

21. A computer program product being embodied in a tangible non-transitory computer readable storage medium and comprising computer instructions for:
searching in a page to locate a link having an empty link address based on empty link attribute features;
substituting a preset auxiliary page address for the empty link address within the located link;
performing simulated triggering on the link having the auxiliary page address substituted for the empty link address;
determining whether the simulated triggering has opened an auxiliary page to obtain a determination result; and
determining whether the empty link address in the link was erroneously set as an empty link based on the determination result.
